(19) United States
(12) Patent Application Publication
(10) Pub. No.: US 2009/0072442 A1
(43) Pub. Date: Mar. 19, 2009

(54) Apparatus and method for molding plastics having relief decoration

(75) Inventor: Chun-Yuan Chang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/953,869

(22) Filed: Dec. 11, 2007

(30) Foreign Application Priority Data
Sep. 19, 2007 (CN) 200710201772.1

(51) Int. Cl. B29C 45/14; B29C 45/04; B29C 45/16

(52) U.S. Cl. 264/275; 425/110; 425/111

(57) ABSTRACT

An apparatus for molding plastics having relief decorations includes a mold, a foil, and a transport. The mold defines a cavity therein. The foil has a printed layer, and relief patterns are provided on the printed layer. The transport is used for transporting the foil with the printed layer thereon into the mold.

### CROSS-REFERENCE TO RELATED APPLICATIONS

Relevant subject matter is disclosed in a co-pending U.S. patent application (Attorney Docket No. US15155) filed on the same date and entitled “APPARATUS AND METHOD FOR MOLDING PLASTICS HAVING RELIEF DECORATION”, which is assigned to the same assignee with this application.

### BACKGROUND

1. Field of the Invention

The present invention generally relates to molding apparatuses and methods. Particularly, the present invention relates to an apparatus and a method for molding plastics that have relief decorations.

2. Description of Related Art

Plastics are widely used in peoples' daily life. Some plastics generally have decorative patterns thereon for artistry and beauty. Commonly, after the plastics are molded, the decorative patterns are merely painted on the surfaces of the plastics, and so are easily worn away over time.

An In-Mold-Decoration (IMD) technology is developed to overcome the above defects. The IMD technology incorporates a foil on which decorative patterns are printed. The foil is placed in a cavity bounded by molds. The decorative patterns adhere to the plastic products after the plastics are molded and separated from the cavity, thus forming the decorative patterns on the plastics. However, common IMD technologies can only form planar decorations, but cannot form sculpted relief decorations.

### SUMMARY

In one embodiment, an apparatus for molding plastics having relief decorations includes a mold, a foil, and a transport. The mold defines a cavity therein. The foil has a printed layer, and relief patterns are provided on the printed layer. The transport is used for transporting the foil with the printed layer thereon into the mold.

Other advantages and novel features of the apparatus and method will become more apparent from the following detailed description of preferred embodiments when taken in conjunction with the accompanying drawings, in which:

### BRIEF DESCRIPTION OF THE DRAWINGS

FIG. 1 is a disassembled, cross-sectional view of an apparatus for molding plastics having relief decorations in accordance with an exemplary embodiment of the present invention;

FIG. 2 is an assembled, cross-sectional view of FIG. 1;

FIG. 3 is similar to FIG. 2, but showing an injection view; and

FIG. 4 is a flow chart of a method for molding plastics having relief decorations in accordance with an exemplary embodiment of the present invention.

### DETAILED DESCRIPTION

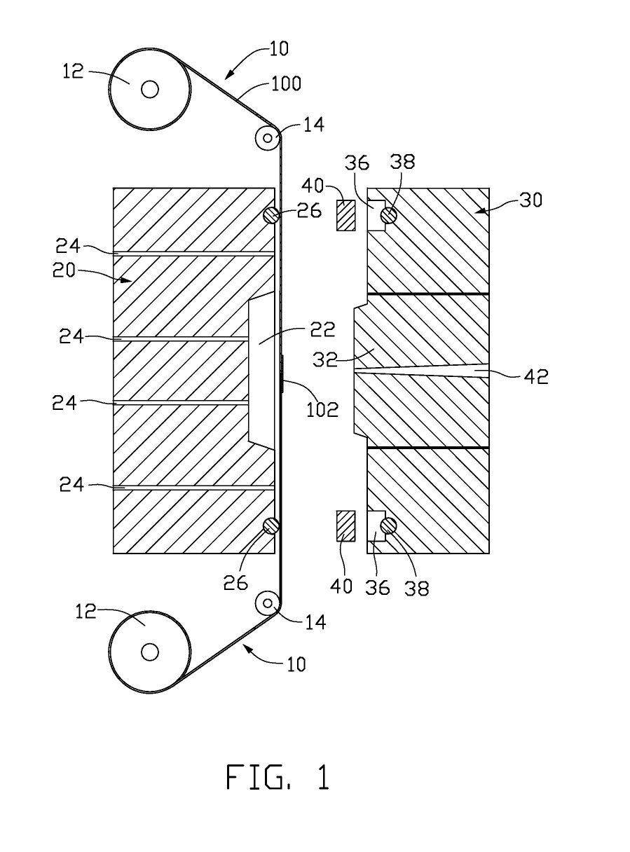

Referring to FIG. 1, an apparatus for molding plastics having relief decorations includes a transport 10, a mold including a female mold 20 and a male mold 30, and a plurality of blocks 40.

The transport 10 includes two transport rollers 12 and two guiding rollers 14 positioned at two opposites side of the mold, respectively, for transporting a foil 100 into the mold between the female and male molds 20, 30.

The foil 100 includes a base (not labeled) and a printed layer 102 attached to the base. The base of the foil 100 is made of macromolecule materials such as polycarbonate (PC) or polybutylene terephthalate (PBT). The printed layer 102 has relief patterns formed thereon. The relief patterns are formed on a side of the printed layer 102 opposite to the side that the printed layer 102 contacts the base. In one embodiment, the printed layer 102 includes a film with relief patterns being formed thereon, and ink that is printed on the relief patterns of the film. In other embodiments, the printed layer 102 has a film, and a printed ink layer with the ink layer being printed thereon to form relief patterns.

The female mold 20 defines a cavity 22 in a first side thereof facing the male mold 30. The female mold 20 defines a plurality of discharge holes 24 extending from the first side of the female mold 20, facing the male mold 30, to a second side opposite to the male mold 30. At least one of the discharge holes 24 is communicated with the cavity 22, at first ends thereof. A vacuum-pump (not shown) is connected to second ends of the discharge holes 24, for discharging air from the cavity 22. A plurality of hermetic rings 26 are attached to the female mold 22 around the cavity 22.

The male mold 30 includes a projection portion 32 protruding towards the female mold 20 corresponding to the cavity 22. The male mold 30 defines an injection opening 42 extending from a side, facing the female mold 20, thereof to the other side thereof. A slot 36 is defined in the male mold 30, facing the female mold 20 and around the projection portion 32. A plurality of hermetic rings 38 are attached to the male mold 30 rounding the projection portion 32, being received in a bottom of the slot 36.

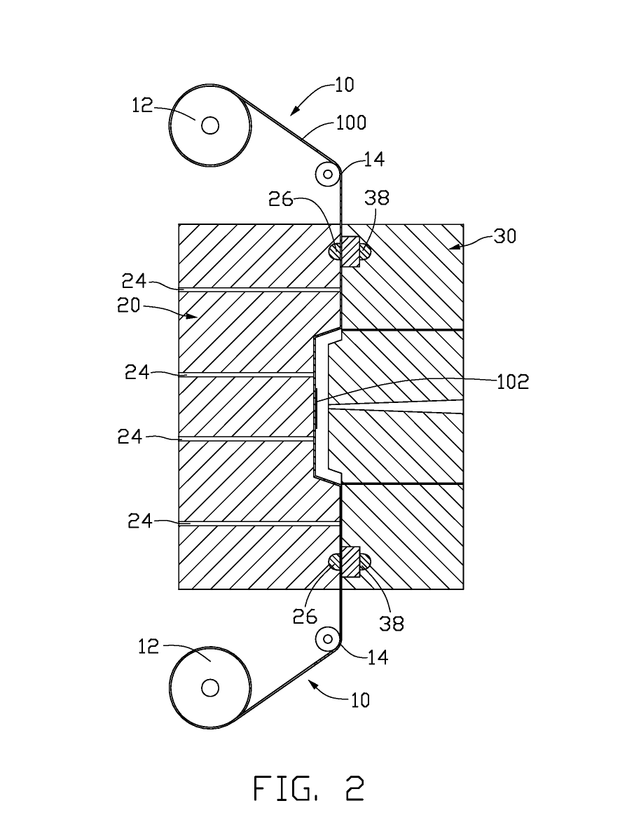

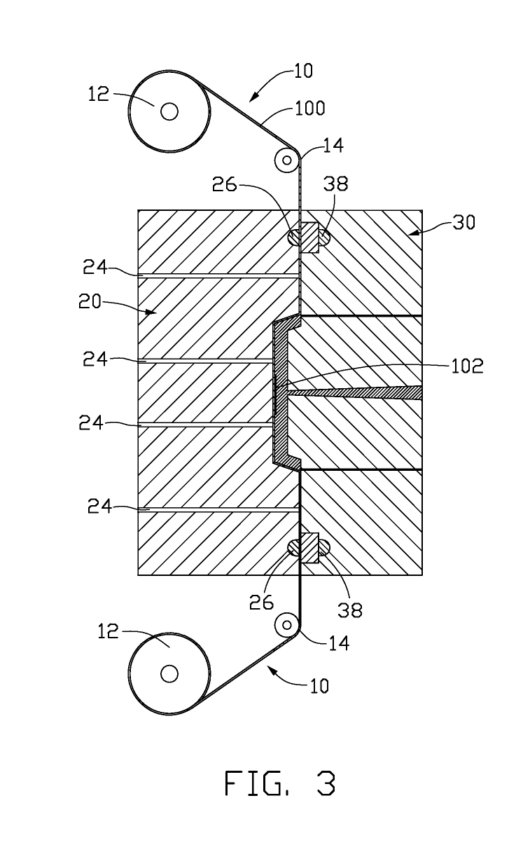

Referring to FIGS. 2 and 3, in use, the transport 10 transports the foil 100 into the mold between the female mold 20 and the male mold 30. The male mold 30 is clamped to the female mold 20, with the blocks 40 being received in the slot 36, the blocks 40 tightly pressing the foil 100 on the female mold 20 and resisting against the hermetic rings 26, 38. The vacuum-pump discharges the air from a space bounded by the foil 100 and the inner surface of the cavity 22 through the discharge holes 24, making the foil 100 tightly attached to the inner surface of the cavity 22. Molten resin is injected into a molding space bounded by the foil 100 and the male mold 30 through the injection opening 42. The molten resin is cooled to form a plastic, with relief decorations formed on a surface thereof. After the male mold 30 is separated from the female mold 20 and the block 40 releases the foil 100 from the female mold 20, the plastic is ejected from the molding space. The printed layer 102 with relief patterns separates from the base of the foil 100 adhered to the plastic. The transport 10 is operated to transport the remaining base of the foil 100 to move out of the mold, and another foil 100 with a printed layer 102 is transported into the mold.

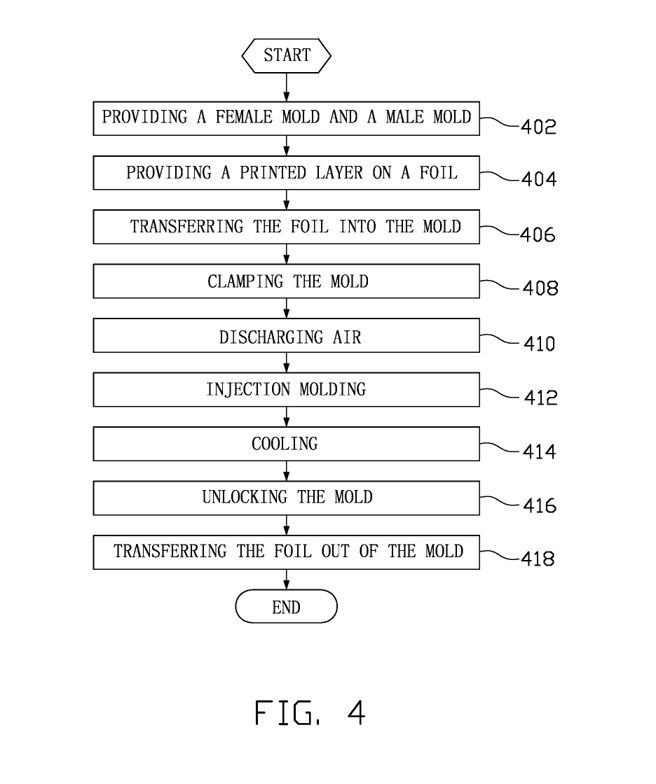

Referring also to FIG. 4, a method for molding plastics having relief decorations in accordance with an exemplary embodiment includes the following steps:

Step 402, providing a mold having a female mold 20 and a male mold 30, the female mold 20 defining a cavity 22 therein.

Step 404, providing a printed layer 102 on a base of a foil 100. The printed layer 102 has relief patterns formed on a side thereof.

Step 406, providing a transport 10 to transport the foil 100 with the printed layer 102 into the mold between the female mold 20 and the male mold 30.

Step 408, clamping the male mold 30 with the female mold 20, and pressing the foil 100 on the female mold 20 via a plurality of blocks 40 being received in a slot 36 defined in the male mold 30. Thus, a space is formed between the foil 100 and an inner surface of the cavity 22.

Step 410, discharging air from the space through a plurality of discharge holes 24 extending through the female mold 20 and communicating with the cavity 22. Therefore, the foil 100 is tightly attached to the inner surface of the cavity 22.

Step 412, injecting molten resin into a molding space bounded by the foil 100 and the male mold 30 through the injection opening 42 extending through the male mold 30 from the surface thereof facing the female mold 20 to the other surface thereof. The injection of the molten resin continues until the molten resin fills the molding space.

Step 414, cooling the molten resin in the molding space.

Step 416, unlocking the mold to separate the male mold 30 from the female mold 20. The plastic is removed from the mold with the printed layer 102 adhering to a corresponding surface of the plastic. Therefore, a plastic with relief decorations is formed.

Step 418, the transport 10 transports the remaining base of the foil 100 out of the mold, and returns to step 406.

The apparatus and method provide the relief patterns on the printed layer of the foil, therefore the plastics are formed with the relief decorations thereon. The relief decorations are firmly and durably formed on the plastics.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An apparatus for molding plastics having relief decorations comprising:
a mold defining a cavity therein;
a foil having a printed layer, and relief patterns being provided on the printed layer; and
a transport for transporting the foil with the printed layer thereon into the mold.

2. The apparatus as described in claim 1, wherein the mold comprises a male mold and a female mold, the cavity is defined in the female mold, and the foil is transported into the mold between the male mold and the female mold.

3. The apparatus as described in claim 1, wherein the printed layer comprises a film with ink printed thereon.

4. The apparatus as described in claim 3, wherein the relief patterns are formed on the film, and the ink is printed on the relief patterns.

5. The apparatus as described in claim 3, wherein the ink is printed on the film to form the relief patterns.

6. The apparatus as described in claim 1, wherein the mold defines at least one discharge hole, for discharging air from a space bounded by the foil and the mold.

7. The apparatus as described in claim 1, wherein the mold further comprises at least one block for pressing the foil on the mold.

8. The apparatus as described in claim 7, wherein the mold further defines a slot for receiving the block.

9. The apparatus as described in claim 8, wherein at least a hermetic ring is received in the slot, for being pressed by the block.

10. A method for molding plastic having relief decorations comprising steps of: providing a mold, the mold defining a cavity therein;
providing a foil with a printed layer having relief patterns thereon;
transporting the foil into the mold and aligning the printed layer with the cavity;
injecting molten resin into the cavity of the mold to form the plastic; and
opening the mold, and separating the printed layer attached to a surface of the plastic from the foil, therefore allowing the printed layer to be adhered to the surface of the plastic.

11. The method as described in claim 10, wherein the mold comprises a male mold and a female mold, the cavity being defined in the female mold.

12. The method as described in claim 11, further comprising:
transporting the foil into the mold between the male mold and the female mold, pressing the foil on the mold, therefore forming a space between the foil and the female mold; and
discharging air from the space, for making the foil being tightly attached to an inner surface of the cavity of the female mold.

13. The method as described in claim 10, wherein the printed layer comprises a film with ink printed thereon.

14. The method as described in claim 13, wherein the relief patterns are formed on the film, and the ink is printed on the relief patterns.

15. The method as described in claim 13, wherein the ink is printed on the film to form the relief patterns.

16. The method as described in claim 10, wherein the mold defines at least one discharge hole, for discharging air from a space bounded by the foil and the mold.
